(19) United States
(12) Patent Application Publication
(10) Pub. No.: US 2019/0141169 A1
(43) Pub. Date: May 9, 2019

(54) USER-PLANE PROTOCOL STACK DETERMINING METHOD, CONTROL-PLANE NETWORK ELEMENT, AND SYSTEM

(71) Applicant: HUAWEI TECHNOLOGIES CO., LTD., Shenzhen (CN)

(72) Inventors: Hui NI, Beijing (CN); Yan LI, Beijing (CN); Yongcui LI, Beijing (CN)

(73) Assignee: HUAWEI TECHNOLOGIES CO., LTD., Shenzhen (CN)

(21) Appl. No.: 16/238,923

(22) Filed: Jan. 3, 2019

Related U.S. Application Data
(63) Continuation of application No. PCT/CN2016/088380, filed on Jul. 4, 2016.

(51) Int. Cl. H04L 29/06; H04L 29/08; H04W 76/10

(52) U.S. Cl. CPC H04L 69/24; H04W 76/10; H04L 69/329

(57) ABSTRACT

The present disclosure relates to a user-plane protocol stack determining method, a control-plane network element, and a system. The method includes: obtaining attribute information of a service of a terminal; determining, based on the attribute information of the service, a user-plane protocol stack used to transmit the service, and determining a user-plane network element serving the terminal; and sending protocol stack type indication information of the user-plane protocol stack to the user-plane network element and an access-network network element, where the protocol stack type indication information is used to indicate the user-plane protocol stack corresponding to the user-plane network element and the access-network network element. Therefore, a to-be-used user-plane protocol stack is determined according to different service requirements of the terminal, thereby flexibly meeting the service requirements of the terminal.

### CROSS-REFERENCE TO RELATED APPLICATIONS

This application is a continuation of International Application No. PCT/CN2016/088380, filed on Jul. 4, 2016, the disclosure of which is hereby incorporated by reference in its entirety.

### TECHNICAL FIELD

The present disclosure relates to the field of communications networks, and in particular, to a user-plane protocol stack determining method, a control-plane network element, and a system.

### BACKGROUND

An evolved packet system (EPS) defined in 3GPP TS 23.041 is shown in FIG. 1. The EPS includes two parts: a radio access network and a core network. The radio access network is an evolved universal terrestrial radio access network (E-UTRAN), and is used to implement functions related to radio access. The core network, also referred to as an evolved packet core (EPC), is mainly used to provide a user connection, perform user management, and bear a service, and serves as an interface between a bearer network and an external network.

The EPC mainly includes a mobility management entity (MME), a serving gateway (S-GW), a packet data network gateway (PDN GW), and a home subscriber server (HSS).

The MME is mainly responsible for control-plane mobility management and session management, for example, user authentication, handover, mobility management of a terminal in an idle mode, user context, and bearer management. The HSS stores user subscription information. The S-GW is a user-plane functional entity, completes routing and forwarding of packet data. The S-GW is also a data anchor in a 3GPP system, and an E-UTRAN termination interface. The PDN GW is a gateway connected to an external data network, and is a user-plane anchor between a 3GPP access network and a non-3GPP access network. During actual network deployment, logical network elements such as the S-GW and the PDN GW are deployed in an integrated manner (except in cases such as roaming), and are collectively referred to as a gateway.

In the prior art, a protocol stack used by the EPC is determined based on a protocol supporting capability of a gateway. The GTP-U (GPRS tunneling protocol-user plane) tunneling transport protocol and the PMIP (Proxy Mobile IP Protocol) protocol are usually used.

However, when a fixed protocol stack is determined based on configuration information of a forwarding network element, the need of different protocol stacks to meet different service requirements is not considered in the prior art. Consequently, relatively limited protocol stacks are used in a network, and cannot flexibly meet different service requirements. For example, implementation according to the GTP-U tunneling transport protocol is unnecessary for a fixed terminal (an Internet of Things (IoT) terminal such as a smart meter or a monitor device) or a mobile terminal that does not require IP continuity. Undiscriminating use of the GTP-U tunneling transport protocol stack increases costs of establishing and maintaining the GTP-U tunneling transport protocol.

### SUMMARY

The present disclosure provides a user-plane protocol stack determining method, a control-plane network element, and a system. A to-be-used user-plane protocol stack is determined based on attribute information of a service of a terminal, so that the to-be-used user-plane protocol stack is determined according to different service requirements of the terminal, thereby flexibly meeting the service requirements of the terminal.

According to a first aspect, the present disclosure provides a user-plane protocol stack determining method. The method may include:

obtaining, by a control-plane network element, attribute information of a service of a terminal; determining, by the control-plane network element based on the attribute information of the service, a user-plane protocol stack used to transmit the service, and determining a user-plane network element serving the terminal; and sending, by the control-plane network element, protocol stack type indication information of the user-plane protocol stack to the user-plane network element and an access-network network element, where the protocol stack type indication information is used to indicate the user-plane protocol stack corresponding to the user-plane network element and the access-network network element.

The user-plane protocol stack used to transmit the service is determined based on the attribute information of the service, and the determined protocol stack type indication information is sent to the user-plane network element and the access-network network element, to complete establishing a forwarding path. Therefore, the user-plane protocol stack is dynamically determined according to a service requirement, thereby flexibly meeting different service requirements.

With reference to the first aspect, in a first possible implementation of the first aspect, the attribute information of the service may include one or both of continuity requirement information of the service or quality of service requirement information, and may further include one or more of a type or an identifier of a network slice transmitting the service or other information. The user-plane network element serving the service of the terminal is flexibly determined based on a plurality of attribute information conditions.

With reference to the first aspect or the first possible implementation of the first aspect, in a second possible implementation of the first aspect, the obtaining, by a control-plane network element, attribute information of a service of a terminal may include:

obtaining, by the control-plane network element, the attribute information of the service from a session establishment request message or an attach request message that is sent by the terminal; or

obtaining, by the control-plane network element, the attribute information of the service from user subscription information stored in a subscription data server.

With reference to the first possible implementation of the first aspect, in a third possible implementation of the first aspect, the determining, by the control-plane network element based on the attribute information of the service, a user-plane protocol stack used to transmit the service includes:

determining, by the control-plane network element based on the continuity requirement information of the service, that a tunneling transport protocol stack or a non-tunneling transport protocol stack is used to transmit the service, where the tunneling transport protocol stack is GTP-U, and the non-tunneling transport protocol stack is an IP protocol stack.

With reference to the first possible implementation of the first aspect, in a fourth possible implementation of the first aspect,

the determining, by the control-plane network element based on the attribute information of the service, a user-plane protocol stack used to transmit the service includes:

determining, by the control-plane network element based on the quality of service requirement information, that a bearer-supported transport protocol stack (for example, Generic Routing Encapsulation (GRE) or a non-bearer transport protocol stack is used to transmit the service (for example, Flat IP).

With reference to the first aspect, in a fifth possible implementation of the first aspect, the determining a user-plane network element serving the terminal may include: determining, by the control-plane network element based on the user-plane protocol stack and a protocol supporting capability of the user-plane network element, the user-plane network element serving the terminal. The control-plane network element may further determine, based on a network topology or a load balancing status, a user-plane network element that can provide an optimal service for service transmission.

With reference to the first aspect, in a sixth possible implementation of the first aspect, the sending, by the control-plane network element, protocol stack type indication information of the user-plane protocol stack to the user-plane network element and an access-network network element includes:

sending, by the control-plane network element, the protocol stack type indication information of the user-plane protocol stack to the user-plane network element and the access-network network element by using a forwarding path establishment request message, to indicate the protocol stack corresponding to the user-plane network element and the access-network network element, where the forwarding path establishment request message carries the protocol stack type indication information of the user-plane protocol stack.

With reference to the first aspect, in a seventh possible implementation of the first aspect, the sending protocol stack type indication information of the user-plane protocol stack to the user-plane network element and an access-network network element includes:

sending, by the control-plane network element, the protocol stack type indication information of the user-plane protocol stack to the user-plane network element and the access-network network element according to a packet forwarding rule configured by using a software-defined networking SDN controller control protocol, to indicate the protocol stack corresponding to the user-plane network element and the access-network network element. The packet forwarding rule carries the protocol stack type indication information of the user-plane protocol stack.

With reference to any one of the first aspect and the possible implementations of the first aspect, in an eighth possible implementation of the first aspect, the protocol stack type indication information is represented by using an identifier of the user-plane protocol stack or an information element held by the user-plane protocol stack.

According to a second aspect, the present disclosure provides a control-plane network element. The control-plane network element includes:

an obtaining unit, configured to obtain attribute information of a service of a terminal;

a determining unit, configured to determine, based on the attribute information of the service, a user-plane protocol stack used to transmit the service, and determine a user-plane network element serving the terminal; and

a sending unit, configured to send protocol stack type indication information of the user-plane protocol stack to the user-plane network element and an access-network network element, where the protocol stack type indication information is used to indicate the user-plane protocol stack corresponding to the user-plane network element and the access-network network element.

The user-plane protocol stack used to transmit the service is determined based on the attribute information of the service, and the determined protocol stack type indication information is sent to the user-plane network element and the access-network network element, to complete establishing a forwarding path. Therefore, the user-plane protocol stack is dynamically determined according to a service requirement, thereby flexibly meeting different service requirements.

With reference to the second aspect, in a first possible implementation of the second aspect, the attribute information of the service includes one or more of continuity requirement information of the service, quality of service requirement information, or a type or an identifier of a network slice transmitting the service.

With reference to the second aspect or the first possible implementation of the second aspect, in a second possible implementation of the second aspect, the obtaining unit is configured to:

obtain the attribute information from a request message sent by the terminal, where the request message is a session establishment request message or an attach request message; or

obtain the attribute information from user subscription information stored in a subscription data server S.

With reference to the first possible implementation of the second aspect, in a third possible implementation of the second aspect, the determining unit is configured to:

determine, based on the continuity requirement information of the service, that a tunneling transport protocol stack or a non-tunneling transport protocol stack is used to transmit the service.

With reference to the first possible implementation of the second aspect, in a fourth possible implementation of the second aspect, the determining unit may be configured to:

determine, based on the quality of service requirement information, that a bearer-supported transport protocol stack or a non-bearer transport protocol stack is used to transmit the service.

With reference to the second aspect, in a fifth possible implementation of the second aspect, the determining unit is configured to:

determine, based on the user-plane protocol stack and a protocol supporting capability of the user-plane network element, the user-plane network element serving the terminal.

With reference to the second aspect, in a sixth possible implementation of the second aspect, the sending unit is configured to:

send the protocol stack type indication information of the user-plane protocol stack to the user-plane network element and the access-network network element by using a forwarding path establishment request message, where the forwarding path establishment request message carries the protocol stack type indication information of the user-plane protocol stack.

With reference to the second aspect, in a seventh possible implementation of the second aspect, the sending unit is configured to:

send the protocol stack type indication information of the protocol stack to the user-plane network element and the access-network network element according to a packet forwarding rule configured by using a software-defined networking SDN controller control protocol, where the packet forwarding rule carries the protocol stack type indication information of the user-plane protocol stack.

With reference to any one of the second aspect and the possible implementations of the second aspect, in an eighth possible implementation of the second aspect, the protocol stack type indication information is represented by using an identifier of the user-plane protocol stack or an information element held by the user-plane protocol stack.

According to a third aspect, the present disclosure provides a system. The system includes the control-plane network element according to any one of the second aspect or the possible implementations of the second aspect, a user-plane network element, an access-network network element, and a terminal. The user-plane network element is configured to process and forward a packet, and the access-network network element is configured to provide wireless network access for the terminal.

According to the user-plane protocol stack determining method and the system provided in the present disclosure, the user-plane protocol stack is dynamically determined based on the attribute information of the service, and the protocol stack type indication information is sent to the user-plane network element. Therefore, a to-be-used user-plane protocol stack is flexibly determined according to a service requirement of a terminal.

### BRIEF DESCRIPTION OF DRAWINGS

To describe the technical solutions in the embodiments of the present disclosure more clearly, the following briefly describes the accompanying drawings required for describing the embodiments of the present disclosure. Apparently, the accompanying drawings in the following description show merely some embodiments of the present disclosure, and a person of ordinary skill in the art may derive other drawings from these accompanying drawings without creative efforts.

FIG. 1 is a schematic architectural diagram of a core network in the prior art;

FIG. 2 is a schematic architectural diagram of a mobile communications network according to an embodiment of the present disclosure;

FIG. 3 is a schematic structural diagram of a control-plane network element according to an embodiment of the present disclosure;

FIG. 4 is a flowchart of a user-plane protocol stack determining method according to an embodiment of the present disclosure;

FIG. 5 is a flowchart of another user-plane protocol stack determining method according to an embodiment of the present disclosure;

FIG. 6 is a flowchart of still another user-plane protocol stack determining method according to an embodiment of the present disclosure; and

FIG. 7 is a schematic structural diagram of a control-plane network element according to an embodiment of the present disclosure.

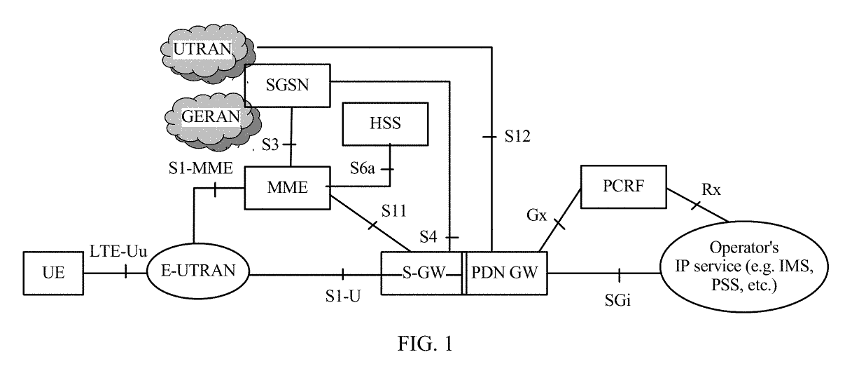

### DESCRIPTION OF EMBODIMENTS

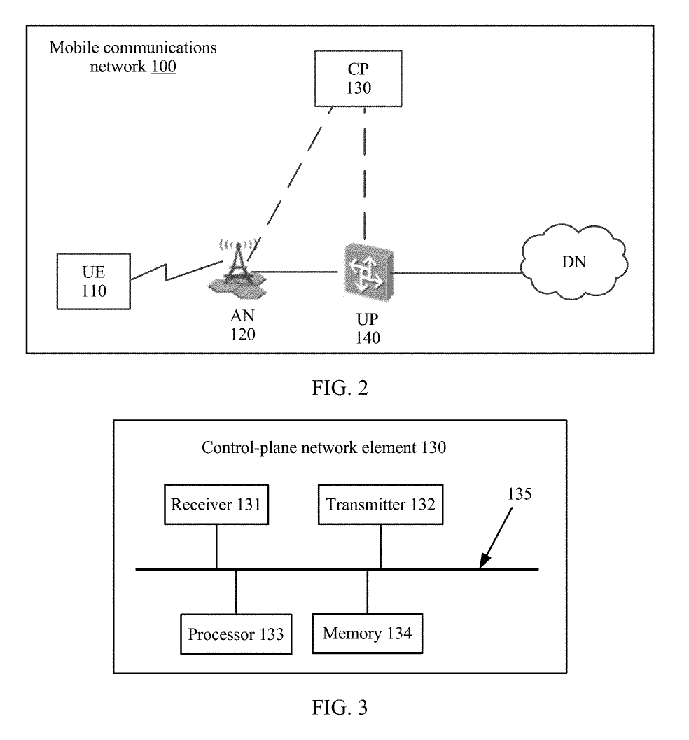

An embodiment of the present disclosure provides a mobile communications network architecture, as shown in FIG. 2.

A mobile communications network 100 includes a terminal (User Equipment, UE) 110, an access-network (AN) network element 120, a control-plane (CP) network element 130, and a user-plane (UP) network element 140. The terminal UE 110 is connected to the control-plane CP network element 130 and the user-plane UP network element 140 by using the access-network AN network element 120. The user-plane UP network element is connected to a data network (DN).

In this embodiment of the present disclosure, the terminal UE 110 is a network terminal device, and may include but is not limited to a mobile phone, a network access terminal device, an Internet of Things terminal device, and the like. The access-network AN network element 120 may include but is not limited to an eNodeB, Wireless Fidelity (Wi-Fi), an access point (AP), a Worldwide Interoperability for Microwave Access (WiMAX) base station, and the like, and provide a wireless access service for the terminal UE 110.

The control-plane CP network element 130 may include a software-defined networking (SDN) controller, a gateway control-plane device (GW-C), a mobility management entity (MME), and the like, or some or all of control functions formed by integrating the foregoing network elements. The control-plane CP network element 130 is responsible for mobility management (MM) and/or session management (SM) on a mobile network. For example, the control-plane CP network element 130 delivers a packet forwarding policy to a gateway forwarding plane, and instructs a GW-U to process and forward a packet according to the packet forwarding policy. The user-plane UP network element 140 may include a forwarding device of a physical or virtual machine, such as a PDN GW, an S-GW, a router, or a switch, and is responsible for packet processing and forwarding. The data network DN may include a packet data network (PDN) such as the Internet and an IP multimedia service, and is used to provide a data transmission service for a terminal (or a user of a terminal).

According to a user-plane protocol stack determining method, a control-plane network element, and a system provided in the present disclosure, the control-plane CP network element 130 dynamically determines a to-be-used user-plane protocol stack according to a service requirement of a terminal, to flexibly meet different service requirements.

In an embodiment of the present disclosure, as shown in FIG. 3, the control-plane network element 130 may include a receiver 131, a transmitter 132, a processor 133, a memory 134, and a communications bus 135. The receiver 131, the transmitter 132, the processor 133, and the memory 134 are connected to each other by using the communications bus 135, to implement communication with each other.

The receiver 131 is configured to receive data sent by another device in a mobile network communications system. The transmitter 132 is configured to send data information to a forwarding plane device of the system. The memory 134 is configured to store data and an instruction. The processor 133 is configured to invoke the instruction in the memory 134 and complete a corresponding operation.

In this embodiment of the present disclosure, the processor 133 may be another general purpose processor, a digital signal processor (DSP), an application-specific integrated circuit (ASIC), a field programmable gate array (FPGA) or another programmable logic device, a discrete gate or transistor logic device, or a discrete hardware component. The general purpose processor may be a microprocessor, or the processor may be any conventional processor or the like.

The communications bus 135 may further include a power bus, a control bus, a status signal bus, and the like, in addition to a data bus. However, for clear description, various types of buses in the figure are marked as the communications bus 135.

The memory 134 may include a read-only memory and a random access memory, and provide an instruction and data for the processor 133. A part of the memory may further include a non-volatile random access memory.

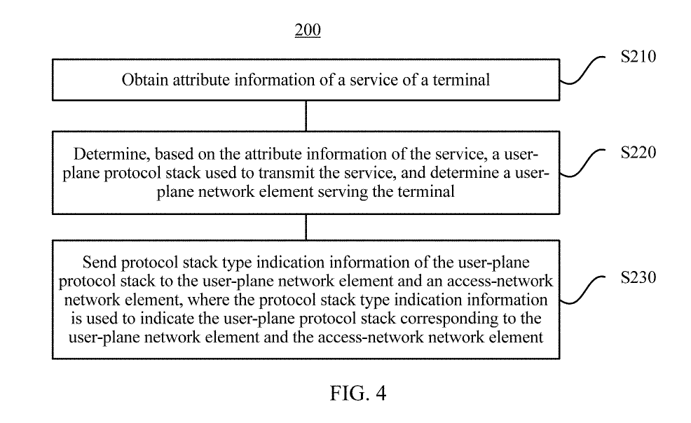

For ease of description, the following describes in detail the technical solutions of the embodiments of the present disclosure with reference to FIG. 4. It should be understood that this is merely an example to describe the technical solutions of the embodiments of the present disclosure, but is not construed as any limitation on the embodiments of the present disclosure.

FIG. 4 is a flowchart of a user-plane protocol stack determining method according to an embodiment of the present disclosure. The method 200 may be executed by the control-plane CP network element 130 in FIG. 2 or FIG. 3. As shown in FIG. 4, the method 200 may include the following steps.

S210. Obtain attribute information of a service of a terminal.

In this embodiment of the present disclosure, the attribute information of the service may include one or more of continuity requirement information of the service, quality of service (QoS) requirement information, or a type or an identifier of a network slice transmitting the service.

It should be noted that the attribute information of the service in this embodiment of the present disclosure may be attribute information of each session or attribute information of a network slice granularity. The network slice includes network functions and resources running these network functions.

The continuity requirement information of the service is used to indicate whether the service is a session service or a network slice service that requires continuity or a session service or a network slice service that does not require continuity. The identifier of the network slice is used to distinguish between network slices. In this embodiment of the present disclosure, a continuous session service or a continuous network slice service may be described as a mobile session service or a mobile network slice service. The quality of service QoS requirement information, also referred to as QoS control granularity requirement information, may include a terminal UE granularity, a flow granularity, and the like.

Specifically, in this embodiment of the present disclosure, the control-plane network element may obtain the attribute information of the service in two manners. Manner one: The control-plane network element receives a session establishment request message or an attach request message that is sent by the terminal by using an access-network network element, and obtains the attribute information of the service from the session establishment request message or the attach request message. The session establishment request message is a request message used to establish a connection service between the terminal and a network. The attach request message is a request message used by the terminal to register with a network. Manner two: The control-plane network element obtains the attribute information of the service from user subscription information stored in a subscription data server, to determine a service requirement of the service.

S220. Determine, based on the attribute information of the service, a user-plane protocol stack used to transmit the service, and determine a user-plane network element serving the terminal.

The control-plane network element determines, based on the attribute information of the service, a protocol stack to be used by a user-plane device. Examples are shown below:

If the attribute information is a session or a network slice that does not require continuity, a device-granularity tunneling transport protocol or a non-tunneling transport protocol may be used for the user-plane protocol stack. The non-tunneling transport protocol may be, for example, an IP protocol stack. The tunneling transport protocol may include GTP-U, Layer 2 Tunneling Protocol (L2TP), GRE, Virtual Extensible Local Area Network (VxLAN), Multiprotocol Label Switching-Transport Profile (MPLS-TP), IP-in-IP, and the like.

If the attribute information is a session or a network slice that requires continuity, a session-granularity tunneling transport protocol may be used.

If the attribute information is a session or a network slice that requires fine-granularity QoS control, a bearer-supported transport protocol such as GTP-U or GRE may be used. The fine-granularity QoS control may be, for example, a service flow granularity.

If the attribute information is a session or a network slice that does not require fine-granularity QoS control, a non-bearer transport protocol such as IP-in-IP or Flat IP may be used. A QoS control granularity may be a UE granularity.

If the attribute information is a session or a network slice that requires continuity and fine-granularity QoS control, a bearer-supported tunneling transport protocol such as GTP-U or GRE may be used.

If the attribute information is a session or a network slice that does not require continuity but requires fine-granularity QoS control, a bearer-supported non-tunneling transport protocol or a bearer-supported device-granularity tunneling transport protocol such as GTP-U or GRE may be used.

If the attribute information is a session or a network slice that requires continuity but does not require fine-granularity QoS control, a non-bearer tunneling transport protocol such as IP-in-IP or VxLAN may be used.

If the attribute information is a session or a network slice that does not require continuity or fine-granularity QoS control, a non-bearer non-tunneling transport protocol or a non-bearer device-granularity tunneling transport protocol such as the Flat IP protocol may be used.

If the attribute information is an Ethernet-connected session or an Ethernet-connected network slice, an L2 (layer 2) protocol stack may be used.

In this embodiment of the present disclosure, the attribute information may further include a type or an identifier of a network slice transmitting a service. The slice identifier may be used as a unique identifier to distinguish between network slices.

If the attribute information is a network slice of an enhanced mobile broadband (eMBB) type, a user-plane protocol stack such as the GTP-U protocol may be used.

If the attribute information is a network slice of a sensor type, a user-plane protocol stack such as the Flat IP protocol may be used.

If the attribute information is a V2X network slice that requires mobility and fine-granularity QoS control, a user-plane protocol stack such as the GTP-U protocol may be used.

If the attribute information is a network slice 1 that does not require mobility or fine-granularity QoS control, a user-plane protocol stack such as the Flat IP protocol may be used.

In this embodiment, the network slice identifier may be identified by using numbers such as 1, 2, and 3, or another identifier may be used to distinguish between network slices. In this embodiment of the present disclosure, a form of the network slice identifier is not limited.

In this embodiment of the present disclosure, the control-plane network element may determine, based on a protocol supporting capability of the user-plane network element, an appropriate user-plane network element serving the terminal. When establishing a connection to the user-plane network element, the control-plane network element obtains protocol supporting capability information of the user plane network element through negotiation. Alternatively, the control-plane network element obtains protocol supporting capability information of the user plane network element through local configuration.

When the control-plane network element determines the to-be-used protocol stack based on continuity requirement information or QoS requirement information, of a session or a network slice, included in the attribute information, the control-plane network element determines, based on the determined protocol stack and the obtained user-plane network element protocol supporting capability information, user-plane network elements that can support the user-plane protocol stack determined based on the attribute information, and determines one or more user-plane network elements that support the user-plane protocol stack.

In this embodiment of the present disclosure, the control-plane network element may further filter, based on a network topology or load balancing, the user-plane network elements that support the user-plane protocol stack, to select, from the user-plane network elements that support the user-plane protocol stack, a user-plane network element that can provide an optimal service for the terminal.

S230. Send protocol stack type indication information of the user-plane protocol stack to the user-plane network element and an access-network network element, where the protocol stack type indication information is used to indicate the user-plane protocol stack corresponding to the user-plane network element and the access-network network element.

In this embodiment of the present disclosure, the protocol stack type indication information may be represented by using a protocol stack identifier (PROTO_ID), or an information element identifier held by a protocol stack (For example, for a GTP-U protocol stack, a tunnel endpoint identifier (TEID) of the GTP protocol may be used to represent a protocol stack type; for a GRE protocol stack, a GRE key is used to represent a protocol stack type; and for an Ethernet protocol stack, an MPLS label may be used to represent a protocol stack type).

After the control-plane network element determines the user-plane network element, the control-plane network element sends, to the access-network network element and the determined user-plane network element that supports the protocol stack, the protocol stack type indication information of the user-plane protocol stack that is determined based on an attribute of the service, so that the access-network network element and the user-plane network element can determine the corresponding user-plane protocol stack based on the received protocol stack type indication information. When receiving a user packet related to a session or a network slice, the access-network network element and the user-plane network element may transmit the packet according to the determined user-plane protocol stack.

In this embodiment of the present disclosure, the control-plane network element may send, in two manners, to the access-network network element and the determined user-plane network element that supports the user-plane protocol stack, the protocol stack type indication information of the user-plane protocol stack that is determined based on the attribute of the service. Manner one: The control-plane network element sends a forwarding path establishment request to the access-network network element and the user-plane network element. The forwarding path establishment request carries the protocol stack type indication information. Manner two: The control-plane network element configures a forwarding pipeline to the access-network network element and the user-plane network element by using an SDN controller control protocol. In other words, the control-plane network element sends a packet forwarding rule to the access-network network element and the user-plane network element. The packet forwarding rule includes the protocol stack type indication information.

According to the user-plane protocol stack determining method provided in this embodiment of the present disclosure, the to-be-used user-plane protocol stack is determined based on the attribute information of the service, and the determined protocol stack type indication information is sent to the user-plane network element and the access-network network element, to complete establishing a forwarding path. Therefore, the user-plane protocol stack is dynamically determined according to a service requirement, thereby flexibly meeting different service requirements.

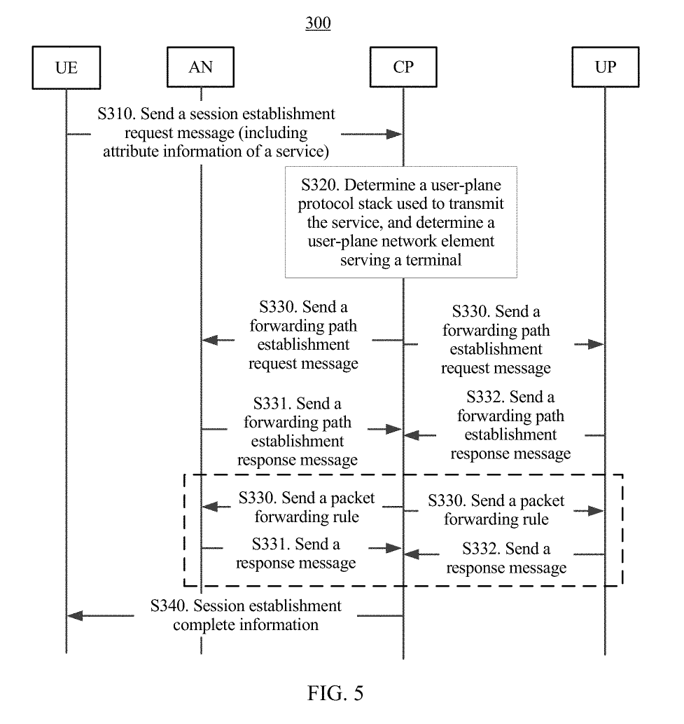

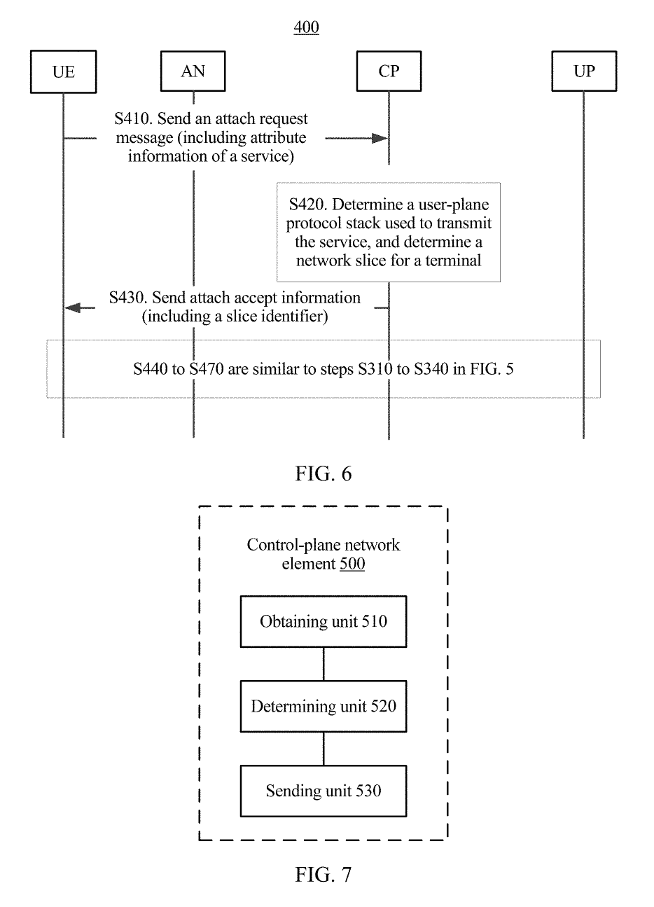

FIG. 5 is a flowchart of a user-plane protocol stack determining method 300 according to an embodiment of the present disclosure. For example, the attribute information is a session granularity. As shown in FIG. 5, the method 300 may include the following steps.

S310. A terminal sends a session establishment request message to a control-plane network element.

The session establishment request message includes attribute information of a session, and may include continuity requirement information of the session, or referred to as mobility requirement information of the session, or/and quality of service QoS requirement information.

The terminal sends a session establishment request to the control-plane network element by using an access-network network element. In this embodiment of the present disclosure, the access-network network element may be a base station in a 5G network. The control-plane network element may be a session management network element.

S320. The control-plane network element determines, based on attribute information of a session, a user-plane protocol stack used to transmit a service, and determines a user-plane network element supporting the protocol stack.

In this embodiment of the present disclosure, the control-plane network element determines, based on the attribute information of the session, the to-be-used user-plane protocol stack. There are the following examples.

If the attribute information is a session that does not require mobility, use of a device-granularity tunneling transport protocol or a non-tunneling transport protocol may be determined. The non-tunneling transport protocol may be, for example, an IP protocol stack.

If the attribute information is a session that requires mobility, a session-granularity tunneling transport protocol may be used. The tunneling transport protocol may include GTP-U, Layer 2 Tunneling Protocol (L2TP), GRE, Virtual Extensible Local Area Network (VxLAN), Multiprotocol Label Switching-Transport Profile (MPLS-TP), IP-in-IP, and the like.

If the attribute information is a session or a network slice that requires a fine-granularity QoS control granularity, a bearer-supported transport protocol such as a GTP-U or GRE protocol stack may be used. The fine-granularity QoS control may be, for example, a service flow granularity.

If the attribute information is a session or a network slice that does not require fine-granularity QoS control, a non-bearer transport protocol such as IP-in-IP or Flat IP may be used. A QoS control granularity may be a UE granularity.

If the attribute information is a session or a network slice that requires continuity and fine-granularity QoS control, a bearer-supported tunneling transport protocol such as GTP-U or GRE may be used.

If the attribute information is a session or a network slice that does not require continuity but requires fine-granularity QoS control, a bearer-supported non-tunneling transport protocol or a bearer-supported device-granularity tunneling transport protocol such as GTP-U or GRE may be used.

If the attribute information is a session or a network slice that requires continuity but does not require fine-granularity QoS control, a non-bearer tunneling transport protocol such as IP-in-IP or VxLAN may be used.

If the attribute information is a session or a network slice that does not require continuity or fine-granularity QoS control, a non-bearer non-tunneling transport protocol or a bearer-supported device-granularity tunneling transport protocol such as the Flat IP protocol may be used.

If the attribute information is an Ethernet-connected session, a data link layer, such as a MAC layer protocol stack, namely, an L2 (layer 2) protocol stack, may be used.

In this embodiment of the present disclosure, when establishing a connection to the user-plane network element, the control-plane network element obtains protocol supporting capability information of the user plane network element through negotiation. Alternatively, the control-plane network element obtains protocol supporting capability information of the user plane network element through local configuration. The control-plane network element may determine, based on the determined user-plane protocol stack and the obtained protocol supporting capability information of the user-plane network element, an appropriate user-plane network element serving the terminal.

It should be noted that the finally determined user-plane network element may be all or some of user-plane network elements included in the system.

In this embodiment of the present disclosure, the control-plane network element may further determine, based on a network topology or a load balancing status from user-plane network elements that support the user-plane protocol stack, a user-plane network element that can provide an optimal service for the terminal.

S330. The control-plane network element sends a forwarding path establishment request message to an access-network network element and the user-plane network element, where the forwarding path establishment request message carries protocol stack type indication information of the user-plane protocol stack.

The forwarding path establishment request message is used to establish a forwarding path between the access-network network element and the user-plane network element. The protocol stack type indication information is used to indicate the user-plane protocol stack corresponding to the access-network network element and the user-plane network element, so that the access-network network element and the user-plane network element can process a packet of the terminal according to the corresponding user-plane protocol stack.

The protocol stack type indication information may be represented by using a protocol stack identifier of a protocol stack type, or by using an information element identifier held by a protocol stack. For example, for a GTP-U protocol stack, a GTP TEID may be used to represent a protocol stack type; for a GRE protocol stack, a GRE key may be used to represent a protocol stack type; and for an Ethernet protocol stack, an MPLS label may be used to represent a protocol stack type.

Optionally, in this embodiment of the present disclosure, the method may further include the following steps.

S331. The access-network network element sends forwarding path establishment response information to the control-plane network element.

S332. The user-plane network element sends forwarding path establishment response information to the control-plane network element.

It should be noted that step S330 to step S332 provide a general description as follows: The control-plane network element sends, to the access-network network element and the user-plane network element, the protocol stack type indication information carried in the forwarding path establishment request message, so that the access-network network element and the user-plane network element can process a packet of the terminal according to the user-plane protocol stack indicated in the protocol stack type indication information. For a specific user-plane protocol stack, step S330 to step S332 need to be adjusted appropriately. For example, the control-plane network element determines that the to-be-used user-plane protocol stack is GTP-U. Details are as follows:

(1) The control-plane network element sends a first forwarding path establishment request message to the access-network network element. The first forwarding path establishment request message carries a user-plane network element TEID. The user-plane network element TEID is an information element identifier held by the GTP-U protocol, and is used as protocol stack type indication information.

(2) The access-network network element sends a first forwarding path establishment response message to the control-plane network element. The first forwarding path establishment response message carries an access-network network element TEID.

(3) The control-plane network element sends a second forwarding path establishment request message to the user-plane network element. The second forwarding path establishment request message carries an access-network network element TEID. The access-network network element TEID is an information element identifier held by the GTP-U protocol, and is used as protocol stack type indication information.

(4) Optionally, the user-plane network element sends a second forwarding path establishment response message to the control-plane network element.

It should be noted that in another embodiment of the present disclosure, the method 300 may further include the following steps.

S330′. The control-plane network element configures a forwarding pipeline to an access-network network element and the user-plane network element by using an SDN controller control protocol, in other words, the control-plane network element sends a packet forwarding rule to the access-network network element and the user-plane network element, where the packet forwarding rule carries protocol stack type indication information.

The protocol stack type indication information may be represented in a same manner as that of the protocol stack type indication information in S330. For brevity, details are not described herein again.

The packet forwarding rule sent to the access-network network element and the user-plane network element is used to instruct the user-plane network element and the access-network network element to complete establishing a forwarding path. Optionally, in S331′, the access-network device network element sends response information to the control-plane network element.

Optionally, in S332′, the user-plane device network element sends response information to the control-plane network element.

The following uses a GRE protocol stack and a Flat IP protocol stack as an example for description. Details are as follows:

(1) When the GRE protocol stack is used, in S330, the control-plane network element sends a packet forwarding rule to an access-network network element, where the packet forwarding rule is as follows:

uplink: match(UL flow in the session), action(QoS enforcement, push_GRE_header, set GRE key(key1), set GRE_src_IP(AN IP), set GRE_dst_IP(UP IP),output); and

downlink: match(GRE key2), action(QoS enforcement, pop_GRE_header, output to radio bearer).

Uplink is corresponding to a processing rule specific to a packet that is sent by the terminal, and downlink is corresponding to a processing rule specific to a packet that is sent to the terminal. In uplink, match(UL flow in the session) represents an uplink service flow matching a session; action(QoS enforcement, push_GRE_header, set GRE key(key1), set GRE_src_IP(AN IP), set GRE_dst_IP(UP IP),output) represents that executed actions include quality of service QoS enforcement, adding a GRE header, setting a GRE key to key1, setting a source identifier (an identifier IP of an access-network AN network element), and setting a destination identifier (an identifier of a user-plane UP network element).

Optionally, in S331′, the access-network network element sends forwarding path establishment response information to the control-plane network element.

In S330, the control-plane network element sends a packet forwarding rule to the user-plane network element, where the packet forwarding rule is as follows:

uplink: match(GRE key1), action(QoS enforcement, pop_GRE_header, output); and

downlink: match(DL flow in the session), action(QoS enforcement, push_GRE_header,set GRE_src_IP(UP IP), set GRE_dst_IP(AN IP), output).

Optionally, in S332′, the user-plane network element sends forwarding path establishment response information to the control-plane network element.

(2) When the Flat IP protocol stack is used, in S330, the control-plane network element sends a packet forwarding rule to an access-network network element, where the packet forwarding rule is as follows:

uplink: match(UL flow in the session), action(QoS enforcement, output); and

downlink: match(DL flow in the session), action(QoS enforcement, output).

Optionally, in S331′, the access-network network element sends forwarding path establishment response information to the control-plane network element.

In S330, the control-plane network element sends a packet forwarding rule to the user-plane network element, where the packet forwarding rule is as follows:

uplink: match(UL flow in the session), action(QoS enforcement, output); and

downlink: match(DL flow in the session), action(QoS enforcement, output).

Optionally, in S332′, the user-plane network element sends forwarding path establishment response information to the control-plane network element.

S340. The control-plane network element sends session establishment complete information to the terminal by using the access-network network element.

In this case, when receiving a user packet related to the session, the access-network network element or the user-plane network element may transmit the packet according to the established forwarding path. A user-plane protocol stack used for the forwarding path is determined based on the attribute information of the session. Therefore, the user-plane protocol stack is dynamically determined based on an attribute of the session, and the forwarding path is established, thereby processing and forwarding the user packet related to the session.

FIG. 6 is a flowchart of a user-plane protocol stack determining method 400 according to an embodiment of the present disclosure. For example, the attribute information is a network slice granularity. As shown in FIG. 6, the method 400 may include the following steps.

S410. A terminal sends an attach request message to a control-plane network element by using an access-network network element.

The attach request message may carry attribute information of a network slice. For example, the attribute information may include one or more of the following information: continuity requirement information, quality of service QoS requirement information, a network slice type, or a network slice identifier. The continuity requirement information is used to indicate whether the network slice is a network slice that requires mobility or a network slice that does not require mobility. The network slice identifier is used to distinguish between network slices, and may be used as a unique identifier to distinguish between network slices.

The attach request message is request information used for registering with a network for the terminal. For example, when powered on, the terminal performs an attach procedure.

S420. The control-plane network element determines, based on the attach request message, a user-plane protocol stack used to transmit a service, and determines a network slice for the terminal.

Examples are shown below:

If the attribute information is a network slice that does not require continuity, a device-granularity tunneling transport protocol or a non-tunneling transport protocol may be used. The non-tunneling transport protocol may be, for example, an IP protocol stack.

If the attribute information is a network slice that requires continuity, a session-granularity tunneling transport protocol may be used. The tunneling transport protocol stack may include GTP-U, L2TP, GRE, VxLAN, MPLS-TP, IP-in-IP, and the like.

If the attribute information is a network slice that requires a fine-granularity QoS control granularity, a bearer-supported transport protocol may be used, such as a GTP-U or GRE protocol stack. The fine-granularity QoS control may be, for example, a service flow granularity.

If the attribute information is a network slice that does not require fine-granularity QoS control, a non-bearer transport protocol such as IP-in-IP or Flat IP may be used. A QoS control granularity may be a UE granularity.

If the attribute information is a network slice that requires continuity and fine-granularity QoS control, a bearer-supported tunneling transport protocol such as GTP-U or GRE may be used.

If the attribute information is a network slice that does not require continuity but requires fine-granularity QoS control, a bearer-supported non-tunneling transport protocol or a bearer-supported device-granularity tunneling transport protocol such as GTP-U or GRE may be used.

If the attribute information is a network slice that requires continuity but does not require fine-granularity QoS control, a non-bearer tunneling transport protocol such as IP-in-IP or VxLAN may be used.

If the attribute information is a network slice that does not require continuity or fine-granularity QoS control, a non-bearer non-tunneling transport protocol or a bearer-supported device-granularity tunneling transport protocol such as the Flat IP protocol may be used.

If the attribute information is an Ethernet-connected network slice, an L2 protocol stack may be used.

If the attribute information is a network slice of an eMBB type, a user-plane protocol stack such as the GTP-U protocol may be used.

If the attribute information is a network slice of a sensor type, a user-plane protocol stack such as the Flat IP protocol may be used.

If the attribute information is a vehicle-to-everything (V2X) network slice that requires mobility and fine-granularity QoS control, a user-plane protocol stack such as the GTP-U protocol may be used.

If the attribute information is a network slice identifier 1 that does not require mobility or fine-granularity QoS control, a user-plane protocol stack such as the Flat IP protocol may be used.

In this embodiment, the network slice identifier may be identified by using numbers such as 1, 2, and 3, or another identifier may be used to distinguish between network slices. In this embodiment of the present disclosure, a form of the network slice identifier is not limited.

S430. The control-plane network element sends attach accept information to the terminal by using the access-network network element, where the attach accept information carries a slice identifier.

It should be noted that in this embodiment of the present disclosure, S410 to S430 are a mobility management process. This embodiment of the present disclosure further includes S440 to S470. S440 to S470 are a session management process, and are similar to a process of S310 to S340 shown in FIG. 5. For brevity, details are not described herein again.

It should be noted that, different from S310, the session establishment request in S440 carries a slice type or a slice identifier.

The session management process S440 to S470 and the mobility management process S410 to S430 may be performed simultaneously. To be specific, S410 includes a session establishment request message of S440, and S430 includes session establishment complete information. A specific execution process may be S410-S420-S450-S460-S470-S430.

The foregoing describes in detail the protocol stack determining method according to the embodiments of the present disclosure with reference to FIG. 4 to FIG. 6. The following describes in detail a control-plane network element according to an embodiment of the present disclosure with reference to FIG. 7.

FIG. 7 is a schematic structural diagram of a control-plane network element 500 according to an embodiment of the present disclosure. As shown in FIG. 7, the control-plane network element 500 may include an obtaining unit 510, a determining unit 520, and a sending unit 530.

The obtaining unit 510 is configured to obtain attribute information of a service of a terminal.

The determining unit 520 is configured to determine, based on the attribute information of the service, a user-plane protocol stack used to transmit the service, and determine a user-plane network element serving the terminal.

The sending unit 530 is configured to send protocol stack type indication information of the user-plane protocol stack to the user-plane network element and an access-network network element. The protocol stack type indication information is used to indicate the user-plane protocol stack corresponding to the user-plane network element and the access-network network element.

Specifically, in this embodiment of the present disclosure, the control-plane network element may include a software-defined networking controller, a gateway control-plane device GW-C, a mobility management entity MME, and the like, or some or all of control functions formed by integrating the foregoing network elements.

The user-plane network element may include a forwarding device of a physical or virtual machine, such as a PDN GW, an S-GW, a router, or a switch.

The access-network network element may include but is not limited to a base station, Wireless Fidelity Wi-Fi, an access point AP, a Worldwide Interoperability for Microwave Access WiMAX base station, and the like, and is configured to provide a wireless access service for a terminal UE.

The obtaining unit 510 of each control-plane network element has a function of obtaining attribute information of each session or each network slice.

Optionally, in an embodiment of the present disclosure, the obtaining unit 510 may obtain the attribute information of the service in two manners. Manner one: The obtaining unit 510 obtains the attribute information of the service from a session establishment request message or an attach request message that is sent by the terminal. Manner two: The obtaining unit 510 obtains the attribute information from user subscription information stored in a subscription data server.

It should be noted that the attribute information of the service in this embodiment of the present disclosure may be a session service or a network slice granularity service.

In this embodiment of the present disclosure, the attribute information of the service may include one or more of continuity requirement information, quality of service requirement information, a type of a network slice serving the terminal, and a network slice identifier.

The continuity requirement information included in the attribute information of the service is used to indicate a session or a network slice that requires continuity (or mobility) or a session or a network slice that does not require continuity (or mobility). The quality of service requirement information is used to indicate a session or a network slice that requires quality of service control or a session or a network slice that does not require quality of service control. The network slice identifier is used to distinguish between network slices, and may be used as a unique identifier to distinguish between network slices.

The determining unit 520 determines, based on the continuity requirement information or/and the quality of service requirement information in the attribute information of the service, the to-be-used user-plane protocol stack.

In this embodiment of the present disclosure, if the attribute information is a session or a network slice that does not require continuity, a device-granularity tunneling transport protocol or a non-tunneling transport protocol may be used. The non-tunneling transport protocol may be an IP protocol stack. The tunneling transport protocol may include GTP-U, L2TP, GRE, VxLAN, MPLS-TP, IP-in-IP, and the like.

If the attribute information is a session or a network slice that requires continuity, a session-granularity transport protocol may be used.

If the attribute information is a session or a network slice that requires a fine-granularity QoS control granularity, a bearer-supported tunneling transport protocol such as GTP-U or GRE may be used. The fine-granularity QoS control may be, for example, a service flow granularity.

If the attribute information is a session or a network slice that does not require fine-granularity QoS control, a non-bearer transport protocol such as IP-in-IP or Flat IP may be used. A QoS control granularity may be a UE granularity.

If the attribute information is a session or a network slice that requires continuity and fine-granularity QoS control, a bearer-supported tunneling transport protocol such as GTP-U, GRE may be used.

If the attribute information is a session or a network slice that does not require continuity but requires fine-granularity QoS control, a bearer-supported non-tunneling transport protocol or a bearer-supported device-granularity tunneling transport protocol such as GTP-U or GRE may be used.

If the attribute information is a session or a network slice that requires continuity but does not require fine-granularity QoS control, a non-bearer transport protocol such as IP-in-IP or VxLAN may be used.

If the attribute information is a session or a network slice that does not require continuity or fine-granularity QoS control, a non-bearer non-tunneling transport protocol or a non-bearer device-granularity tunneling transport protocol such as the Flat IP protocol may be used.

If the attribute information is an Ethernet-connected session or an Ethernet-connected network slice, an L2 protocol stack may be used.

In this embodiment of the present disclosure, the determining unit 520 may determine the user-plane protocol stack based on the network slice type or the network slice identifier, or may determine the to-be-used user-plane protocol stack based on all the information included in the attribute information. An implementation process may be the same as the example described in S420 in FIG. 4. In this embodiment of the present disclosure, different user-plane protocol stacks may be determined based on different network slice types or different network slice identifiers.

The determining unit 520 may determine, based on a protocol supporting capability of the user-plane network element, the user-plane network element serving the terminal. In this embodiment of the present disclosure, when establishing a connection to the user-plane network element, the control-plane network element obtains protocol supporting capability information of the user plane network element through negotiation. Alternatively, the control-plane network element obtains protocol supporting capability information of the user plane network element through local configuration.

After determining the to-be-used protocol stack based on the attribute information of the service, the determining unit 520 determines, based on the determined to-be-used user-plane protocol stack and the obtained protocol stack supporting capability information, the user-plane network element that can support the determined protocol stack.

In this embodiment of the present disclosure, the determining unit 520 may further filter, based on a network topology or load balancing, user-plane network elements that support the user-plane protocol stack, to select, from the user-plane network elements that support the user-plane protocol stack, a user-plane network element that can provide an optimal service for the terminal.

The sending unit 530 sends the protocol stack type indication information to the determined user-plane network element and the access-network network element, so that the access-network network element and the user-plane network element can establish a forwarding path based on the protocol stack type indication information.

Optionally, in another embodiment of the present disclosure, the sending unit 530 may send the protocol stack type indication information in two manners. Manner one: The sending unit sends, to the access-network network element and the user-plane network element, a forwarding path establishment request message carrying the protocol stack type indication information, and sends the protocol stack type indication information to the access-network network element and the user-plane network element. Manner two: The sending unit sends the protocol stack type indication information to the access-network network element and the user-plane network element when sending a packet forwarding rule to the access-network network element and the user-plane network element. The packet forwarding rule is configured by using a software-defined networking SDN controller control protocol, and the packet forwarding rule carries the protocol stack type indication information.

The control-plane network element according to this embodiment of the present disclosure determines, based on the attribute information of the service, the to-be-used user-plane protocol stack, and sends the determined protocol stack type indication information to the user-plane network element and the access-network network element, to complete establishing a forwarding path. Therefore, the user-plane protocol stack is dynamically determined according to a service requirement, thereby flexibly meeting different service requirements.

It should be noted that in this embodiment of the present disclosure, the units shown in FIG. 7 can implement the methods/steps shown in FIG. 4 to FIG. 6. For brevity, details are not described herein again.

In the several embodiments provided in this application, it should be understood that the disclosed system, control-plane network element, and user-plane protocol stack determining method may be implemented in other manners. For example, the described control-plane network element embodiment is merely an example. For example, the unit division is merely logical function division or may be other division in actual implementation. For example, a plurality of units or components may be combined or integrated into another system. In addition, the displayed or discussed mutual couplings or direct couplings or communication connections may be implemented through some interfaces, through indirect couplings or communication connections between the apparatuses or units, or through electrical connections, mechanical connections, or connections in other forms. The units described as separate parts may or may not be physically separate, and parts displayed as units may or may not be physical units, and may be located in one position or may be distributed on a plurality of network units. Some or all of the units may be selected according to actual requirements to achieve the objectives of the solutions of the embodiments of the present disclosure. In addition, functional units in the embodiments of the present disclosure may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present disclosure essentially, or the part contributing to the prior art, or all or some of the technical solutions may be implemented in the form of a software product. The computer software product is stored in a storage medium and includes several instructions for instructing a computer device (which may be a personal computer, a server, a network device, or the like) to perform all or some of the steps of the methods described in the embodiments of the present disclosure. The foregoing storage medium includes any medium that can store program code, such as a USB flash drive, a removable hard disk, a read-only memory (ROM), a random access memory (RAM), a magnetic disk, or an optical disc.

The foregoing descriptions are merely specific implementations of the present disclosure, but are not intended to limit the protection scope of the present disclosure. Any modification or replacement figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. A method of user-plane protocol stack determining, comprising:
obtaining, by a control-plane network element, attribute information of a service of a terminal;
determining, by the control-plane network element based on the attribute information of the service, a user-plane protocol stack used to transmit the service, and determining a user-plane network element serving the terminal; and
sending, by the control-plane network element, protocol stack type indication information of the user-plane protocol stack to the user-plane network element and an access-network network element, wherein the protocol stack type indication information is used to indicate the user-plane protocol stack corresponding to the user-plane network element and the access-network network element.

2. The method according to claim 1, wherein
the attribute information of the service comprises one or more of continuity requirement information of the service, quality of service requirement information, or a type or an identifier of a network slice transmitting the service.

3. The method according to claim 1, wherein obtaining the attribute information comprises:
obtaining, by the control-plane network element, the attribute information of the service from a request message sent by the terminal, wherein the request message is a session establishment request message or an attach request message; or
obtaining, by the control-plane network element, the attribute information of the service from user subscription information stored in a subscription data server.

4. The method according to claim 2, wherein determining the user-plane protocol stack used to transmit the service comprises:
determining, by the control-plane network element based on the continuity requirement information of the service, that a tunneling transport protocol stack or a non-tunneling transport protocol stack is used to transmit the service.

5. The method according to claim 2, wherein determining the user-plane protocol stack used to transmit the service comprises:
determining, by the control-plane network element based on the quality of service requirement information, that a bearer-supported transport protocol stack or a non-bearer transport protocol stack is used to transmit the service.

6. The method according to claim 1, wherein determining the user-plane network element serving the terminal comprises:
determining, by the control-plane network element based on the user-plane protocol stack and a protocol supporting capability of the user-plane network element, the user-plane network element serving the terminal.

7. The method according to claim 1, sending the protocol stack type indication information comprises:
sending, by the control-plane network element, a forwarding path establishment request message to the user-plane network element and the access-network network element, wherein the forwarding path establishment request message carries the protocol stack type indication information of the user-plane protocol stack.

8. The method according to claim 1, sending the protocol stack type indication information comprises:
sending, by the control-plane network element, the protocol stack type indication information of the user-plane protocol stack to the user-plane network element and the access-network network element according to a packet forwarding rule configured by using a software-defined networking SDN controller control protocol, wherein the packet forwarding rule carries the protocol stack type indication information of the user-plane protocol stack.

9. The method according to claim 1, wherein the protocol stack type indication information is represented by using an identifier of the user-plane protocol stack or an information element held by the user-plane protocol stack.

10. A control-plane network element, comprising:
an interface;
a processor; and
a non-transitory computer-readable storage medium storing a program to be executed by the processor, the program including instructions to:
obtain, using the interface, attribute information of a service of a terminal;
determine, based on the attribute information of the service, a user-plane protocol stack used to transmit the service, and determine a user-plane network element serving the terminal; and
send, using the interface, protocol stack type indication information of the user-plane protocol stack to the user-plane network element and an access-network network element, wherein the protocol stack type indication information is used to indicate the user-plane protocol stack corresponding to the user-plane network element and the access-network network element.

11. The control-plane network element according to claim 10, wherein the attribute information of the service comprises one or more of continuity requirement information of the service, quality of service requirement information, or a type or an identifier of a network slice transmitting the service.

12. The control-plane network element according to claim 10, wherein the program includes instructions to:
obtain, using the interface, the attribute information from a request message sent by the terminal, wherein the request message is a session establishment request message or an attach request message; or
obtain, using the interface, the attribute information from user subscription information stored in a subscription data server.

13. The control-plane network element according to claim 11, wherein the program includes instructions to:
determine, based on the continuity requirement information of the service, that a tunneling transport protocol stack or a non-tunneling transport protocol stack is used to transmit the service.

14. The control-plane network element according to claim 11, wherein the program includes instructions to:
determine, based on the quality of service requirement information, that a bearer-supported transport protocol stack or a non-bearer transport protocol stack is used to transmit the service.

15. The control-plane network element according to claim 10, wherein the program includes instructions to:
determine, based on the user-plane protocol stack and a protocol supporting capability of the user-plane network element, the user-plane network element serving the terminal.

16. The control-plane network element according to claim 10, wherein the program includes instructions to:
send, using the interface, a forwarding path establishment request message to the user-plane network element and the access-network network element, wherein the forwarding path establishment request message carries the protocol stack type indication information of the user-plane protocol stack.

17. The control-plane network element according to claim 10, wherein the program includes instructions to:
send, using the interface, the protocol stack type indication information of the protocol stack to the user-plane network element and the access-network network element according to a packet forwarding rule configured by using a software-defined networking SDN controller control protocol, wherein the packet forwarding rule carries the protocol stack type indication information of the user-plane protocol stack.

18. The control-plane network element according to claim 10, wherein the protocol stack type indication information is represented by using an identifier of the user-plane protocol stack or an information element held by the user-plane protocol stack.

19. A system, comprising:
a control-plane network element;
a user-plane network element to process and forward a packet;
a terminal; and
an access-network network element to provide wireless network access for the terminal;
wherein the control-plane network element obtains attribute information of a service of a terminal; determines, based on the attribute information of the service, a user-plane protocol stack used to transmit the service, and determines a user-plane network element serving the terminal; and sends protocol stack type indication information of the user-plane protocol stack to the user-plane network element and an access-network network element, wherein the protocol stack type indication information is used to indicate the user-plane protocol stack corresponding to the user-plane network element and the access-network network element.
